(19) United States
(12) Patent Application Publication
(10) Pub. No.: US 2002/0085389 A1
(43) Pub. Date: Jul. 4, 2002

(54) Combination of a piece of bodywork and a light unit for a motor vehicle

(75) Inventors: Hugues Cheron, Bourg Saint Christophe (FR); Arnold Fayt, Aromas (FR); Cyrille Rochon, Oyonnax (FR)

Correspondence Address: OLIFF & BERRIDGE, PLC, P.O. BOX 19928, ALEXANDRIA, VA, 22320, US

(73) Assignee: Compagnie Plastic Omnium, Lyon (FR)

(21) Appl. No.: 10/005,143

(22) Filed: Dec. 7, 2001

(30) Foreign Application Priority Data
Dec. 7, 2000 (FR) 0015932

(51) Int. Cl. F21S 8/10; F21V 31/03

(52) U.S. Cl. 362/545; 362/496; 362/547; 362/267; 362/487

(57) ABSTRACT

The invention provides a combination of a piece of bodywork and a light unit for a motor vehicle, the piece of bodywork being to cover a portion of the waistline of the vehicle body and comprising an outside skin formed by a wall of plastics material, the light unit having as component elements both a housing suitable for containing at least one light source and a glass enabling light emitted by said light source to be diffused. The outside skin of the piece of bodywork includes an arrangement forming at least a portion of at least one of the component elements of the light unit.

The present invention relates to a piece of bodywork for a motor vehicle, which piece of bodywork is provided with a light unit.

### BACKGROUND OF THE INVENTION

Motor vehicle light units are known as being relatively expensive, given they are complex in structure.

In addition, it is also expensive to install them on a vehicle since they require the presence of special fixing means such as a bracket for carrying the light unit and located behind part of a fender, and they also require qualified labor to perform assembly proper.

Attempts have already been made to reduce costs by housing at least certain light units directly in pieces of bodywork.

However that solution is limited to a few isolated examples because light units mounted on vehicles in this way are extremely vulnerable.

That is why proposals have never been made to house light units directly in pieces of bodywork that form part of the waistline of a vehicle body, but only to integrate such light units in the roof of a vehicle, as disclosed in German publication No. DE 31 12 686, or at the bottom of the bodywork, as is done for foglights.

The inventors of the present invention have found that one of the main difficulties in mounting light units directly on pieces of bodywork is not only that they are exposed to any impacts that might occur, but that the pieces of bodywork supporting them are subjected to various constraints which cause them to deform by amounts that are generally not tolerable for light units.

This phenomenon is made worse when the pieces of bodywork are themselves made out of synthetic materials.

### OBJECTS AND BRIEF SUMMARY OF THE INVENTION

Starting from observations, the inventors of the present invention have devised a remedy for this inability of light units to accommodate the deformations of pieces of bodywork supporting them.

Thus, the present invention provides a piece of bodywork supporting a light unit for a motor vehicle, the piece of bodywork being for covering a portion of the waistline of the vehicle body and including an outside skin formed by a wall of plastics material, the light unit having as component elements both a housing suitable for containing at least one light source and a glass enabling the light emitted by said light source to be diffused, wherein the outside skin of the piece of bodywork includes an arrangement forming at least a portion of at least one of the component elements of the light unit.

In other words the simple, but a priori non-obvious, idea on which the invention is based, is to reduce the volume occupied by the rigid portions of the light unit to be as small as possible so that any deformation of the piece of bodywork surrounding said light unit can take place without the rigid portions of the light unit being harmed.

Thus, in a first embodiment of the invention, the component element of the light unit formed by the outside skin of the piece of bodywork is the housing of the light unit, such that the rigid portion of the light unit is restricted to the light source and the glass.

The piece of bodywork can thus deform around the light source and the glass with clearance that is sufficient to ensure that the deformation does not give rise to any damage to the light source or to the glass.

Part of the housing can be made by the outside skin of the piece of bodywork, for example if the housing comprises both a support for light sources and a reflector for said light sources, then only the support or only the reflector is formed by an arrangement of the outside skin.

In a particular embodiment, the glass is applied to the housing and is fixed thereto, e.g. by snap-fastening, together with a gasket providing sealing between said glass and said housing.

In a particular variant, the glass has an annular skirt and the housing has a peripheral groove whose bottom is lined with a gasket and in which the annular skirt of the glass is received.

This seals the housing which advantageously includes a vent so as to enable its inside volume to be ventilated.

In a particular embodiment, adapted to the case where the housing is sealed, the light source comprises a set of light-emitting diodes.

In another embodiment of the invention, the glass is itself formed by the outside skin of the piece of bodywork.

In other words, the component element of the light unit formed by the outside skin is the glass.

To this end, it is possible to use a colored or translucent plastics material that is flexible, such as a polyolefin, polyvinyl chloride, polyvinyl acetate, a styrene material, a polyacrylic, a saturated polyester, a polyamide, a polycarbonate, a thermoplastic elastomer, or a metallocene-catalyzed polymer, which material can be co-molded or overmolded in the piece of bodywork or can be stuck or heat sealed thereon.

Under such circumstances, the reflector can be integrated in or supported by the structure of the vehicle, or it can be fitted to the inside of the piece of bodywork.

In any event, it should be understood that the term “glass” as used in the present specification covers any light-passing cover suitable for use with a motor vehicle light unit, and does not need to be made literally of the material glass. Such a “glass” is often also referred to as a “lens”, but that term is also potentially misleading, since there is no need for it to deflect light in any way.

### BRIEF DESCRIPTION OF THE DRAWINGS

In order to make the invention easier to understand, various embodiments thereof are described below as examples that do not limit the scope of the invention in any way, and on the basis of the accompanying sheets of drawings, in which:

FIG. 1 is a three-quarters rear exploded perspective view of a vehicle provided with a bumper constituting a first embodiment of the invention;

FIG. 2 is a section view on II-II of FIG. 1 after uniting the parts shown separate in the exploded view;

FIG. 3 is a section view analogous to FIG. 2 showing a variant embodiment of a bulb-carrying plate;

FIGS. 4 and 5 are analogous to FIGS. 2 and 3 respectively and they show how the light unit behaves when the bumper is deformed;

FIG. 6 is a view analogous to FIG. 1 of a vehicle provided with a bumper constituting a second embodiment of the invention;

FIG. 7 is a three-quarters rear exploded perspective view of another vehicle provided with a bumper constituting a third embodiment of the vehicle;

FIG. 8 is an exploded perspective view of the right-hand rear corner of another vehicle provided with a bumper corner constituting a fourth embodiment of the invention;

FIG. 9 is an exploded perspective view of the right-hand rear corner of another vehicle provided with a bumper corner constituting a fifth embodiment of the invention;

FIG. 10 is an exploded perspective view of a bumper corner forming a sixth embodiment of the invention;

FIG. 11 is a section view on XI-XI of FIG. 10, after uniting the parts shown separate in the exploded view; and

FIG. 12 is a three-quarters rear view of a vehicle including a bumper corner constituting a seventh embodiment.

### MORE DETAILED DESCRIPTION

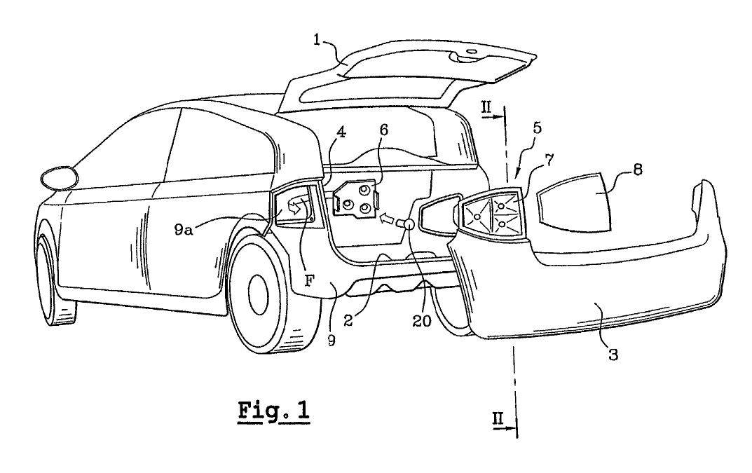

The vehicle shown in FIG. 1 has a tailgate 1 which is shown open.

The tailgate 1 is terminated at the bottom by a sill 2 which is adjacent to a bumper 3 constituted solely by its outside skin, covering the entire bottom portion of the sill 2 and projecting upwards at its side edges 4 where the light units 5 are located.

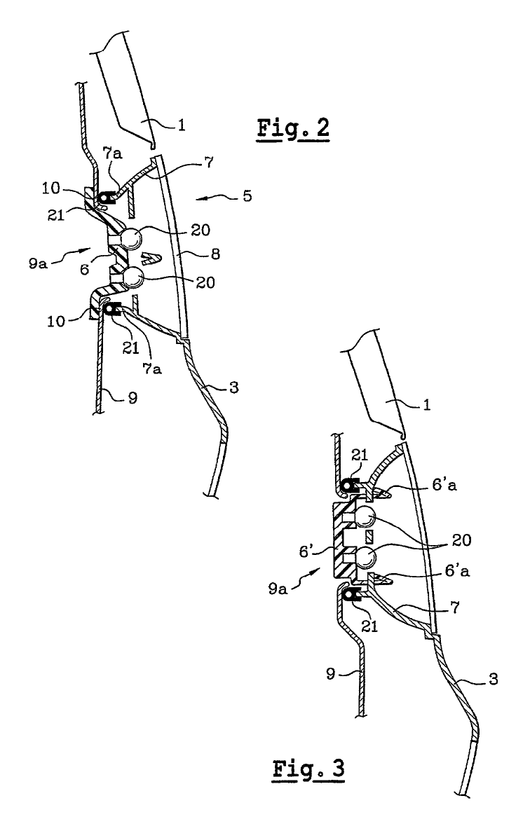

As can be seen in particular in FIG. 2, each unit 5 is constituted by a bulb-carrier plate 6 receiving three bulbs 20, a reflector 7 having a skirt 7a extending towards the inside of the bumper, such that said reflector serves simultaneously as a housing for the light unit, and a colored glass 8 covering the reflector and closing the housing of the light unit.

The reflector 7 and its skirt 7a are made integrally with the bumper 3. They are molded together therewith.

In an advantageous variant, the reflecting surface of the reflector 7 can be obtained by overmolding a chromium- or metal-plated film in the region of the bumper that constitutes said reflector.

The bulb-carrier plate 6 is mounted on the structure 9 from the inside of the vehicle, as represented by arrow F in FIG. 1, and it is fastened to said structure by any suitable conventional means 10, looking into an opening 9a provided for this purpose in said structure.

The reflector 7 takes its place in front of the bulb-carrier plate 6 and the bulb 20 while the bumper 3 is being mounted on the vehicle.

As shown in FIG. 2, a sealing gasket 21 interposed between the skirt 7a of the housing-forming reflector and the structure 9 serves to seal the light unit relative to the outside. In addition, because it surrounds the opening 9a, the gasket 21 also serves to seal said opening 9a, which leads to the inside of the vehicle, relative to the outside.

In the variant of FIG. 3, the bulb-carrier plate 6′ is not fixed to the structure 9, but is fixed to the reflector 7, by means of snap-fastening tabs 6′a.

Thus, the bulb-carrying plate 6′ carrying the bulbs 20 is initially fastened to the reflector 7 of the bumper 3, then the bumper is mounted on the vehicle, thereby positioning the bulb-carrying plate 6′ and the reflector 7 so as to face the opening 9a provided in the structure 9 .

The gasket 21 performs the same functions of sealing the light unit and the opening 9a relative to the outside.

In both variants described above, the colored glass 8 is placed over the reflector 7, possibly with a sealing gasket being interposed between them (not shown). The glass is preferably fastened continuously around its entire periphery so as to avoid any forced concentration arising at particular points of said fastening.

The material used for making the bumper and the reflector of the light unit is sufficiently flexible to accommodate elastic deformation, thereby enabling the light unit to be preserved in the event of the bumper coming into contact with an obstacle.

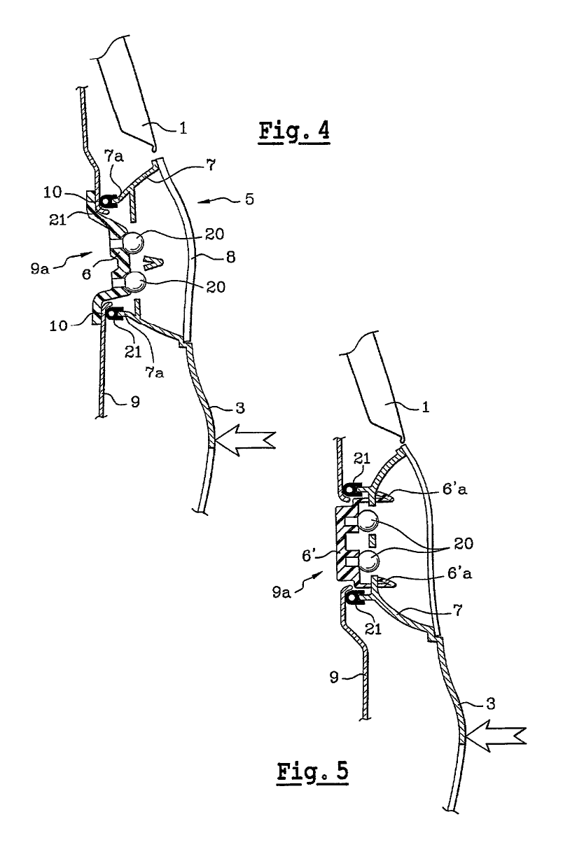

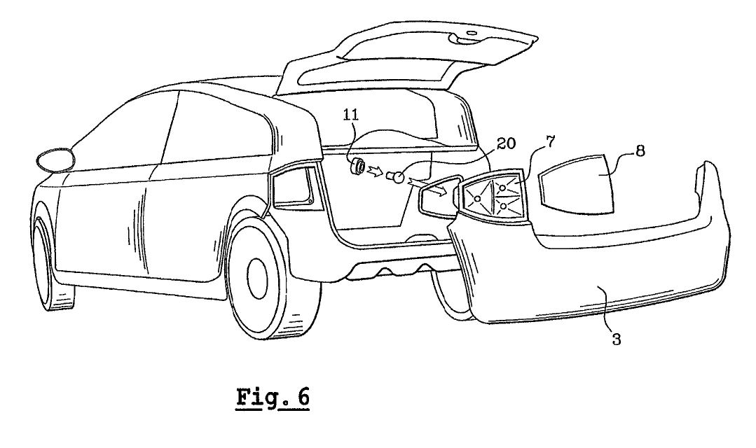

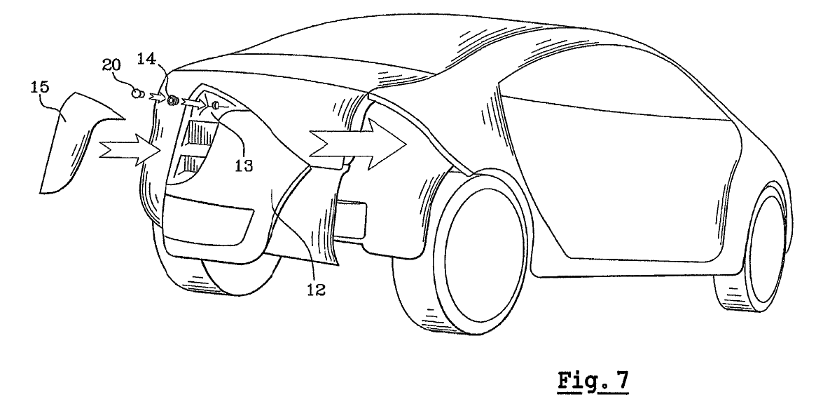

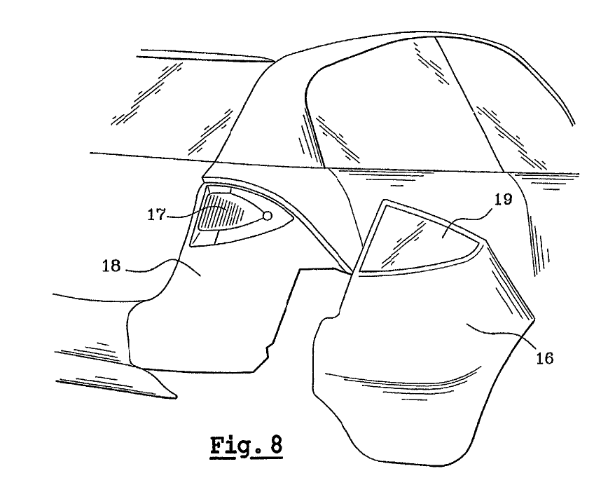

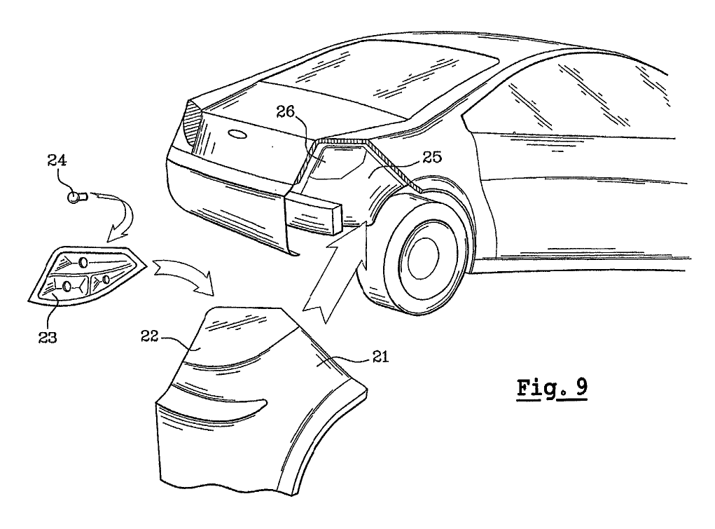

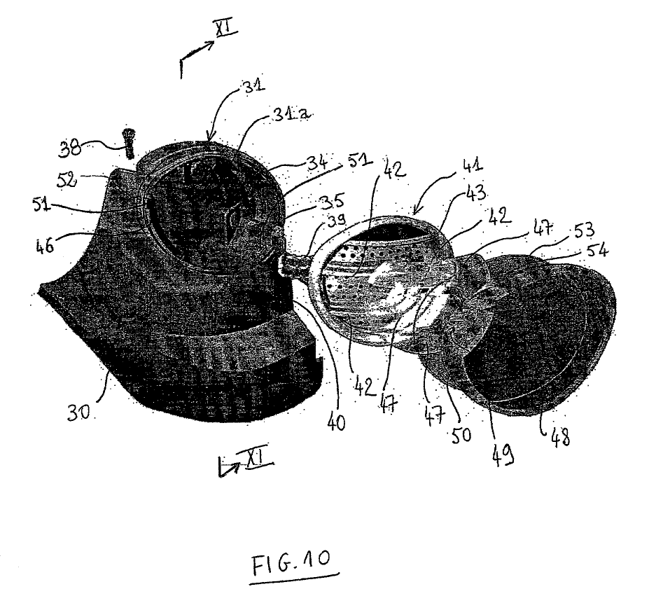

As can be seen in FIGS. 4 and 5, when the bumper deforms, for example because it is pressed against another bumper or an obstacle that is stationary relative to the road, the reflector which is an integral portion of the bumper deforms without difficulty around the bulbs 20. The glass does the same, with this being made particularly easy when it is fastened to the bumper continuously all around its own periphery.

The light unit as a whole is thus preserved, and the only limit is that of the reflector or the glass deforming so much as to come into contact with a bulb and break it, which can be considered in any event as constituting minor damage that is easy to repair.

In the example of FIG. 6, the bumper 3 including the reflector 7 is substantially identical to that described above. In this embodiment, the bulbs 20 are no longer supported by a bulb-carrier plate, but are mounted individually on sockets 11 which snap-fasten in leaktight manner directly on the reflector 7, i.e. directly on the bumper 3.

Since the function of the reflector 7 is to support and contain the bulbs 20, it constitutes the housing of the light unit.

As described above, the colored glass 8 is applied to the reflector 7.

In the embodiment of FIG. 7, the bodywork part of the invention comprises no more than the corner 12 of a bumper.

This bumper corner includes the reflector 13 of a light unit on which the bulbs are mounted via sockets 14 snap-fastened from the outside of the vehicle. As before, the reflector 13 also comprises the housing of the light unit.

This embodiment is particularly suitable for light sources having lifetime longer than that of the vehicle, e.g. light-emitting diodes (LEDs).

In this case, the optionally colored glass 15 can be assembled to the bumper corner in permanent and non-removable manner.

In the embodiment of FIG. 8, the piece of bodywork 16 is likewise a bumper corner.

The reflector 17 of the light unit is integrated in the rear structure 18 of the vehicle, while the colored glass 19 forms an integral portion of the bumper corner 16.

Such a bumper corner can be made by overmolding or by co-injection.

In this example, deformation of the bumper corner is even more easily accommodated by the glass given that the stresses to which it is subjected by deformation are transmitted thereto continuously by the remainder of the bumper, and not via isolated connection points which would concentrate stresses.

In the embodiment of FIG. 9, a bumper corner 21 has in its top portion a glass 22 of translucent material overmolded with the remainder of the bumper corner.

A housing forming three reflectors 23 suitable for receiving three bulbs 24 is shaped so as to be suitable for fitting inside the bumper corner 21, behind the glass 22.

Means for fixing the reflector 23 in the bumper corner 21 can be constituted by snap-fastening, adhesive, heat sealing, or any other appropriate means.

On the vehicle, the structure 25 covered by the bumper corner 21 includes a hatch 26 giving access to the bulbs 24 once the bumper corner is mounted on the vehicle.

Thus, the bulbs 24 can be replaced without dismantling either the piece of bodywork or the elements constituting the light unit. Naturally, such a hatch is pointless when using light sources of very long lifetime such as LEDs.

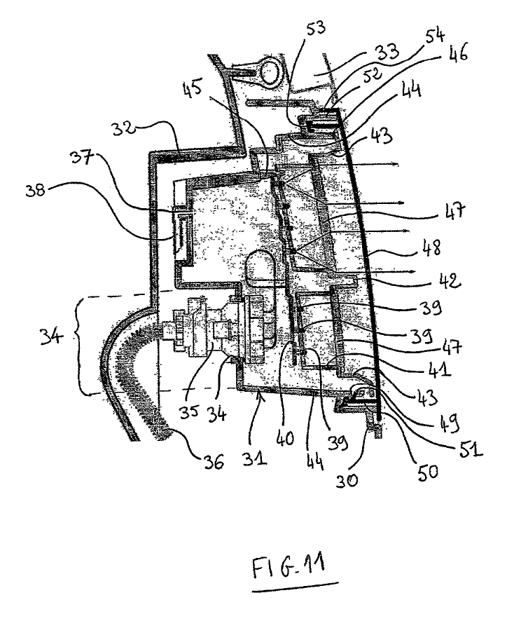

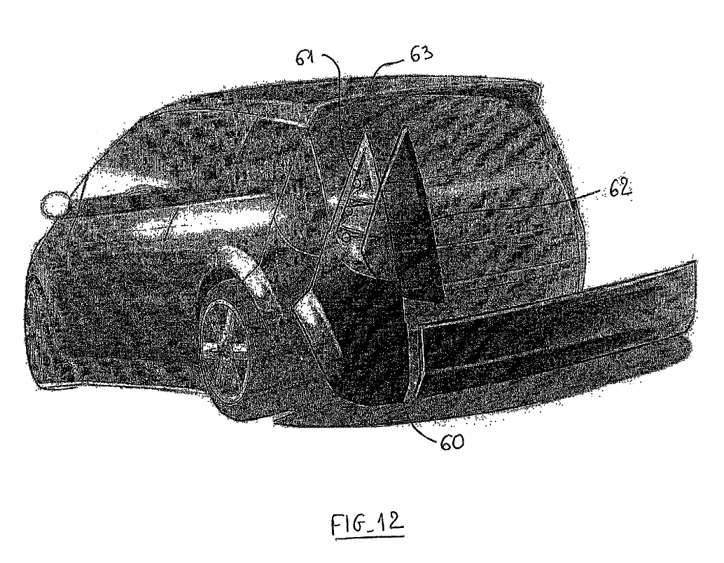

In the embodiment of FIGS. 10 and 11, the piece of bodywork 30 is again a bumper corner. The outside skin of this bumper corner is shaped in its bottom portion so as to extend the central portion (not shown) of the bumper, and in its top portion so as to form a light unit housing 31 which is received in a setback in a structural part 32 at the rear of the vehicle, beneath a door or tailgate 33 so as to extend it.

The end wall 31a of the housing 31 includes a step 34 having an opening formed therethrough to receive an electrical connector 35 connecting the light sources of the unit to an electrical power supply cable 36. A gasket provides sealing between the connector and the housing.

A vent 37 is formed in the top portion of the end wall 31a to put the inside of the housing into communication with the outside. Unlike the housings in the preceding embodiments, in which at least the non-sealed bulb supports provided communication with the outside, the housing 31 is hermetically sealed, as can be seen from the above description, which means that the vent 37 is essential to ensure that the inside of the housing remains under the same conditions of humidity and pressure as the outside so as to prevent mist forming on the inside face of the glass of the unit and so as to avoid pressure building up as could result from the air it contains being heated by the light sources being switched on, or even merely by sunlight.

A downwardly-directed spout 38 covers the outside opening of the vent so as to prevent water or other liquids running over the structural part 32 from penetrating through the vent.

The light sources are LEDs 39 assembled on a carrier 40 which serves both to power them electrically and to arrange them in an array, thus making them easier to install.

In this embodiment, the LEDs 39 are carried by a mask 41 pierced with holes, each serving to receive the light-emitting portion of a corresponding LED 39 on the carrier which is inserted from the back of the mask. In addition, the mask is shaped so as to create separations 42 (only one of which is visible in the section plane of FIG. 11) serving to subdivide the LEDs into three groups, each group emitting light of a different color, for example.

The mask is shaped like a dish having a peripheral rim 43 covering the inside face of the side wall 44 of the housing and extending to its front edge 46 so that the mask appears to constitute the inside of the housing when the light unit is observed from outside the vehicle.

The mask 41 is fastened inside the housing by snap-fastening on a tab 45 projecting from the end wall of the housing, and the peripheral rim 43 of the mask bears against the front edge 46 of the side wall of the housing.

A three-portion light diffuser 47 is received in the mask in front of the LEDs 39 and between the separations 42 of the mask. As represented by the arrows shown in FIG. 11, the diffuser converts the diverging emission of light from the LEDs into a single-direction light beam.

Finally, in front of the light diffuser 47, the housing supports a glass 48 which is fitted to the housing and snap-fastened to its front edge 46 by means of tabs 49 projecting from an annular skirt 50 secured to the housing, and snap-fastening orifices 51 formed in the snap-fastening tabs cut out in the edge 46.

In the vicinity of the edge 46, the wall 44 is surrounded by a rim 52 which co-operates with said wall to form a groove to receive the skirt 50 of the glass, which groove has its bottom wall covered by a gasket 53 against which the skirt presses, thereby sealing the front portion of the housing.

In its top portion, the skirt also has a rim 54 which is provided solely for the sake of appearance.

In the embodiment of FIG. 12, there can be seen a bumper corner 60 including an arrangement 61 forming a light unit housing. A glass 62 is fitted onto this arrangement, as in the embodiment of FIG. 7.

This embodiment is advantageous in that the piece of bodywork 60 extends upwards as far as the roof 63 of the vehicle, thus making it possible to incorporate the arrangement constituting the housing, and thus the light unit itself, in the upper portion of the vehicle. This means that light signaling is more visible and preserves the light unit in the event of minor impacts.

In each of the embodiments of the invention, it can be seen that differential expansion between the component elements of the light unit and between the light unit and the bodywork part surrounding it are minimal, which means that very little clearance needs to be allowed for expansion around these parts and improves overall appearance.

Naturally, the embodiments described above can be combined in a single device of the invention, in which both the housing and the glass are made in the outer skin of the piece of bodywork.

Other modifications of the above-described examples are also possible, without going beyond the ambit of the invention.

1/ A combination of a piece of bodywork and a light unit for a motor vehicle, the piece of bodywork being to cover a portion of the waistline of the vehicle body and comprising an outside skin formed by a wall of plastics material, the light unit having as component elements both a housing suitable for containing at least one light source and a glass enabling light emitted by said light source to be diffused, wherein the outside skin of the piece of bodywork includes an arrangement forming at least a portion of at least one of the component elements of the light unit.

2/ A combination according to claim 1, wherein the component element of the light unit formed by the outside skin is the housing thereof.

3/ A combination according to claim 1, wherein the glass is applied to the housing and is fixed thereto.

4/ A combination according to claim 3, wherein the glass is snap-fastened to the housing, a gasket providing sealing between said glass and said housing.

5/ A combination according to claim 4, wherein the glass includes an annular skirt and the housing includes a peripheral groove whose bottom is lined by a gasket and in which the annular skirt of the glass is received.

6/ A combination according to claim 4, wherein the housing includes a vent for ventilating its inside volume.

7/ A combination according to claim 3, wherein the light source comprises a set of light-emitting diodes.

8/ A combination according to claim 2, wherein the housing is made in part by the outside skin of the piece of bodywork.

9/ A combination according to claim 1, wherein the component element of the light unit formed by the outside skin is the glass.
